(19) United States
(12) Patent Application Publication
(10) Pub. No.: US 2012/0109751 A1
(43) Pub. Date: May 3, 2012

(54) SYSTEM AND METHOD FOR DISTRIBUTING OFFERS TO A POPULATION OF USERS BASED ON RELEVANCY DETERMINATIONS

(76) Inventors: Bill Binenstock, San Francisco, CA (US); Jane Goldman, San Francisco, CA (US); Jonah Schwartz, San Francisco, CA (US); Lainie Cosgrove, San Francisco, CA (US)

(21) Appl. No.: 13/174,695

(22) Filed: Jun. 30, 2011

Related U.S. Application Data
(60) Provisional application No. 61/407,421, filed on Oct. 27, 2010.

(51) Int. Cl. G06Q 30/02

(52) U.S. Cl. 705/14.58; 705/14.64

(57) ABSTRACT

A system and method is provided to enable a merchant to specify an offer that is associated with at least one geographic location. A locality is determined for individual persons comprising a group of users. The locality of the individual persons used to make a determination as to whom the merchant's offer is relevant to. The offer is then electronically communicated to the one or more persons.

### RELATED APPLICATIONS

This application claims benefit of priority to Provisional U.S. Patent Application No. 61/407,421, entitled APPARATUSES, METHODS AND SYSTEMS FOR CONTEXTUAL TARGETED MARKETING, filed Oct. 27, 2010; the aforementioned priority application being hereby incorporated by reference in its entirety.

### TECHNICAL FIELD

Embodiments described herein pertain to a system and method for distributing offers to a population of users based on location and/or relevancy determinations.

### BACKGROUND

Marketing takes place in a variety of environments. Traditional marketing frequently occurs by exploiting channels such as broadcast television, radio and print. Marketing also occurs via the Internet.

### BRIEF DESCRIPTION OF THE DRAWINGS

FIG. 1 illustrates a system architecture for pairing merchant offers to persons based on relevancy determinations, according to one or more embodiments.

FIG. 2 illustrates a method for enabling merchants to specify offers that are paired with persons based on contextual or relevance information, according to one or more embodiments.

FIG. 3 illustrates a method for enabling merchants to specify offers that are paired with persons based on contextual or relevance information, according to one or more embodiments.

FIG. 4 illustrates an implementation in which a user operates a roaming, mobile device that is programmed to receive offer content, in accordance with one or more embodiments.

FIG. 5 illustrates an alternative presentation generated on a client application of a user's mobile device, under another embodiment.

FIG. 6 also illustrates another presentation in which a user is able to provide preference feedback about a particular offer, under another embodiment.

FIG. 7 illustrates an alternative implementation in which a presentation enables a user to browse for offers based on categories, according to one or more embodiments, under another embodiment.

FIG. 8A illustrates an alternative presentation 810 in which a user is displayed a map having points of interest that correspond to the locations where special offers of are provided, under another embodiment.

FIG. 8B illustrates a presentation that enables a user to select the time period (e.g. dinner time, day of week) in order to view offers by location, according to another embodiment.

FIG. 9 illustrates a method for enabling a customer to make payment to a business establishment for a product or service that is being offered to the customer on a discount basis, under an embodiment.

FIG. 10 is a block diagram that illustrates a computer system upon which embodiments described herein may be implemented.

### DETAILED DESCRIPTION

Embodiments described herein enable merchants to selectively communicate geographic-specific and/or time-sensitive offers to a population of consumers based on the relevancy of the offers to the individuals who are selected to receive them.

In some embodiments, geographic-specific offers are selectively distributed to persons that are physically present at a location that is relevant to a geographic region of the merchant. Additionally, time-sensitive offers can be distributed to individuals at instances when the offers are most relevant, and/or with specified conditions or controls that limit, for example, windows in time, or the lifespan of the offer.

Numerous other selection criteria or parameters may be implemented as described herein in order to pair offers from merchants to individuals who would find the offers relevant and of interest.

According to some embodiments, a system and method is provided to enable a merchant to specify an offer that is associated with at least one geographic location. A locality is determined for individual persons comprising a group of users. The locality of the individual persons, relative to the geographic location associated with the offer, is used as a basis for making selections as to whom the merchant's offer is relevant or most relevant to. The offer is then electronically communicated to the selected persons.

Still further, some embodiments include a computer-implemented interface (e.g. online website) that enables merchants to create and distribute offers. As described with various embodiments, a merchant can implement various controls that limit or control, for example, how the offer is distributed, how the offer can be used by consumers, and what the offer can be used for. In one implementation, for example, a merchant can create an offer that is distributed in real-time, with controls that (i) set the expiration period of the offer; (ii) a condition that expires the offer (e.g. a set number of persons who view the offer, rate or indicate their like/dislike for the offer, or use the offer); and/or (iii) the availability of the product or service that can be purchased or otherwise transacted for by persons who receive the offer.

The term “locality” is intended to mean a location for which a user is actually present, such as a street address, intersection, point of interest (e.g. shopping mall, store, landmark) or other region of similar granularity. The locality can be identified through, for example, global positioning system (GPS) and/or latitude/longitudinal coordinates. The locality of a person can differ from, for example, their residence address, as persons can often not be located at their residence (e.g. when a person is at work, driving, walking about town etc.).

According to some embodiments, controls that can be issued with the offer include specifying a timestamp by which the offer is valid. The timestamp can be made specific to the individual user (e.g. a given user has one hour to redeem an offer upon receipt), or the controls provided with the offer can be made global to all users who receive the offer.

Examples provided with some embodiments include offers that pertain to dining or food, provided by merchants such as restaurateurs. In variations, however, embodiments can encompass offers for goods and products, such clothing, electronics, groceries, or services (e.g. hair or nail treatment, dry cleaning), provided by respective stores/merchants.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

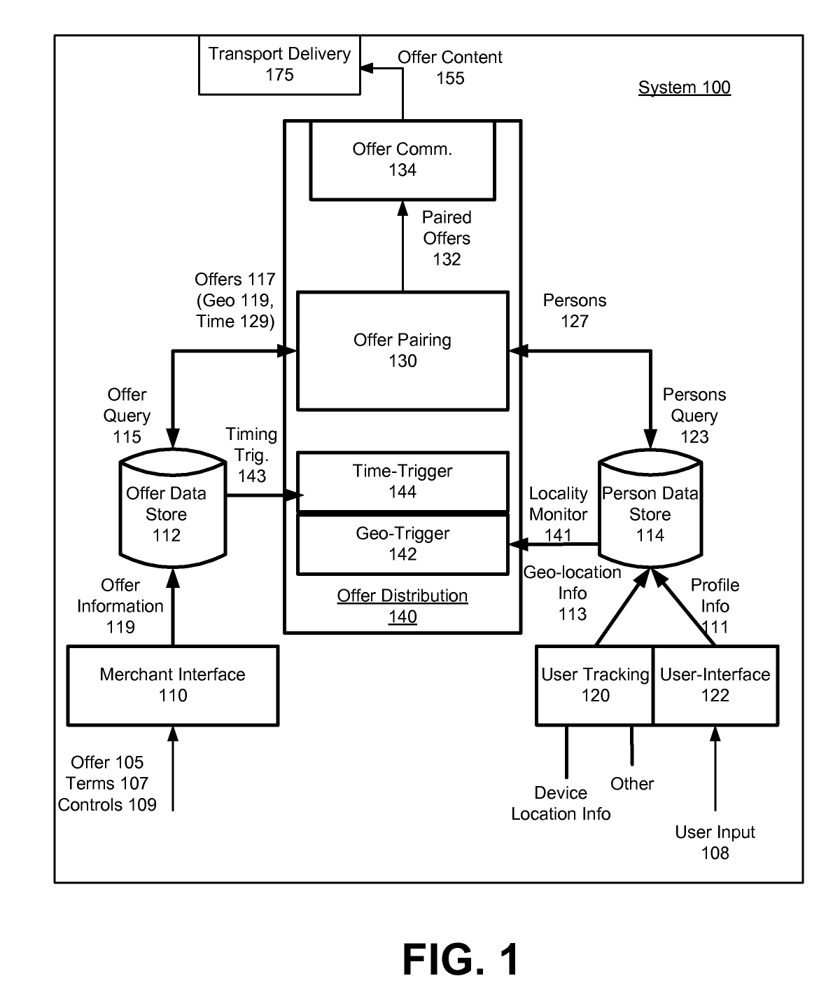

FIG. 1 illustrates a system architecture for pairing merchant offers to persons based on relevance of individual offers to persons, according to one or more embodiments. A system 100 is comprised of components that include merchant interface 110, user tracking sub-system 120, user interface 122, and offer distribution sub-system 140. The offer distribution 140 includes offer pairing 130 and offer communication 134. One or more databases 112, 114 may be used to maintain information about offers, merchants, and users.

According to some embodiments, the system 100 can be implemented by a server, or a combination of servers. For example, system 100 may be implemented from a website or cloud, and generate content (e.g. offers) in the form of messages (e.g. Short Message Service (SMS), email), or through content delivered to an application (e.g. mobile application).

System 100 may operate for users that are merchants and customers. Merchants can, for example, subscribe or otherwise procure rights (e.g. register, provide payment etc.) to utilize the merchant interface 110 to create offers for merchandise and/or goods or services provided by the merchant. For example, the merchant may correspond to an operator of a restaurant or bar, and the merchant may create the offer to specify a discount for a dish, meal, visit, products or other products/services provided by the operator. Still further, merchants can include store owners who offer products such as food items (e.g. groceries, clothing, electronics). More specifically, the merchant interface 110 enables individual merchants to specify an offer 105, including terms 107 of the offer. According to some embodiments, the merchant 103 may also specify controls 109 (which can include offer terms 107) which limit how the offer is to be distributed or used. The offer information 119, generated from individual merchant interaction with merchant interface 110, may be stored in the offer data store 112. The offer information 119 may identify each offer 105, the merchant providing the offer, the geographic location of the merchant (or where the offer is relevant), and controls 109 (if any) specified with the offer.

For users, system 100 provides a service in which customers are able to receive offers via electronic communications (e.g. messages delivered to mobile device) based on various contextual and relevance determinations made about the individual user. Customers can interact with the customer interface 122 to subscribe to such a service. For example, the customers may interface with the customer interface 122 by specifying their email address and/or mobile device phone number. As an alternative or variation, the customer can download a mobile application that operates as an interface to system 100. Still further, the user can elect to use alternative services, such as Instant Messaging services or SKYPE.

When subscribing, a user may perform actions and/or specify information to enable the position of the user to be tracked. For example, a user may download and/or configure an application on a mobile device that communicates with system 100 on an ongoing basis, in order to communicate the position of the user at various instances during a day. A user may also enter profile information 111. The users profile information 111 may include an e-mail address or other messaging/notification identifier (e.g. SMS phone number, Instant Messenger handle, social network identifier etc.). The profile information 111 may also include likely locations of the user, and/or preferences of the user as to a particular class of products or goods (e.g. types of restaurants or pubs the user prefers, favorite places, favorite types of products or merchandise of a particular type etc.). The profile information 111 may identify the user, or alternatively, be uniquely associated with an individual user based on non-identifiable information. For example, if the user downloads an application on his mobile device, the application may carry an identifier that distinguishes the user from other users of system 100, but does not identify the user. The user profile data store 114 may store information about the user, including the users profile information 111.

Regarding descriptions in which personal information is used, users can be provided with an opportunity to opt in/out of services or features which collect personal or private information (e.g. user name, preference, history or past transactions, user locality etc.). Additionally, embodiments can be implemented in a manner that anonymizes the individual users to system 100, so that any information that is collected about the user is not associated with the user's identity. Rather, a user of system 100 can be associated with, for example, a unique identifier, from which the user's true identity is not determinable.

According to some embodiments, the user tracking component 120 tracks a location of the user throughout the course of the day, or portion thereof. Once a user registers or subscribes, for example, to the service provided by system 100, the user may configure or make a mobile device available for tracking by system 100. The user tracking component 120 may be configured to locate and communicate with the geo-aware device of the individual users. For example, mobile devices typically carry global positioning system (GPS) resources that transmit GPS information (e.g. coordinate information) to services that request such information. The user tracking system 120 can monitor the location of the user over the course of, for example, a day or portion thereof. According to some embodiments, geo-location information 113 (as obtained from a user device) is stored about the user on an ongoing basis in the user profile data store 114.

The offer distribution sub-system 140 operates to pair individual offers specified by merchants to users, based on relevance information specified in the offers and/or otherwise known about the persons. According to some embodiments, the offer pairing 130 pairs offers to persons based on various kinds relevancy information, such as (i) the locality of customers relative to the geographic region relevant to the offers, (ii) the timing that is relevant to the offer (e.g. the window of time), (iii) characteristics that the merchant seeks from persons who are to receive or utilize the offer (e.g. new customers, customers who have stopped visiting at regular times), and/or (iv) preferences of the users who receive the offer. The user preferences may be determined from user input and/or from historical activity of the user (e.g. the user may be observed to accept offers for particular types of ethnic restaurants).

In one implementation, the offer pairing 130 performs its pairing functions, by, for example, (i) generating offer queries 115 for offer data store 112, in order to identify offers 117 with timing 129 and geographic parameters 119, and (ii) generating person queries 123 to identify persons 127 that are associated with relevancy parameters suitable for offer pairing. The offers 117 can specify a geographic parameter 119 which identifies, for example, location of the merchant where the offer is provided. The offers 117 can also specify the timing parameter 129, corresponding to, for example, the time of day or date range in which the offer is to be honored.

As an alternative or variation, other parameters may also be specified, such as expiration conditions by which an offer is expired. Expiration conditions can include, for example, the number of persons who are communicated a particular offer, a number of persons who receive or view an offer, a number of persons who provide feedback on an offer, or a number of persons who accept or use an offer. Expiration parameters can also include timing parameters, such as offers that are good for one day.

As another addition or variation, the offer pairing 130 may utilize, for example, a matching algorithm to pair individuals with a relevant offer. In some embodiments, a matching algorithm may use the locality of the user to determine geographic relevancy to the offer/A matching algorithm may also utilize profile information about the user in order to match the individual user with offers from merchants. As examples, the matching algorithm may utilize profile information that includes preference or taste, past feedback provided by the individual user (e.g. the user provided a user review of a business establishment that is relevant to the offer), and/or demographic information.

Accordingly, in an embodiment, the relevancy parameter of the persons identified by the persons queries 123 include the locality of the individuals, as determined by, for example, the tracking component 120, the preferences of the user (as specified by the profile information 111), and/or the availability of the persons at a particular time that is relevant to the timing parameters 129. The locality of individual persons may be matched to the geographic regions associated with available offers to identify which persons (e.g. users) are relevant to each available offer at the given duration. The pairing process may be performed repeatedly during, for example, a day or portion thereof. For example, an offer may be paired to a set of persons if (i) each person in the set is associated with a locality that is near or within the geographic region associated with the offer (ii) at the time specified as being relevant in the offer.

With regard to preference, the individuals likes or dislikes may be used to weight or select a particular pairing in favor or against (e.g. rule out). For example, a given user's profile information 111 may specify a categorical dislike for “Chinese Food”, resulting in the offer distribution 140 not selecting the pairing of the given user to an offer from a Chinese restaurant, despite the offer being relevant by other parameters (e.g. geography and timing).

Offer distribution 140 can operate to identify, at specific times (e.g., lunchtime offers, happy hour offers), both pertinent offers 117 and available persons 127. Offer pairing 130 may pair offers 117 to persons 127 that are deemed available, based on relevancy parameters associated with both the individual offers and persons. Specifically, offers that are relevant to a specific geographic region are paired with persons that have a locality that is deemed proximate to or within that geographic region. The physical location of the user may serve as one parameter for offer pairing. As the locality of customers can be tracked, the offer that is paired to the individual customer may vary from time to time based on geography.

Additionally, considerations may be made for the preferences of the individual customers. For example, the offers provided to a given user may be prioritized (e.g. sequenced or ordering) or weighted to favor some offers over others. If, for example, the customer has a preference for Chinese food based on his input or historical activity, an offer from a Chinese restaurant may be presented first to the user at lunch time, or selected to be shown to the user over another offer for another kind of restaurant. Similarly, in the context of products/goods (e.g. clothing or electronics), offers presented to the user may be prioritized based on location or preference (e.g. the user prefers a particular clothing store).

In many embodiments and implementations, offers are categorized by type to be pertinent to persons at particular intervals of time. For example, merchants may specify lunch offers, dinner offers, happy hour specials, holiday specials, product offerings valid for a duration of time etc. Offer pairing 130 can operate to pair offers by timing category (e.g. lunchtime) to individuals based on geographic parameter matching and/or other parameters (e.g. preferences).

As an addition or alternative, geographic and/or timing triggers 142, 144 may be implemented to identify offers and/or persons for pairing. More specifically, according to some embodiments, offer distribution 140 also operate off of the triggers 142, 144. Geo-trigger 142 corresponds to programming resources which monitor the locality (locality monitor 141) of individual persons that comprise the group of users. When the locality of individual persons changes, triggers 142 may cause the offer distribution 140 to query or otherwise identify offers that are pertinent to the new locality. For example, a user may drive in his car from one neighborhood to another. When arriving at the new neighborhood (or when driving towards the new neighborhood), the trigger 142 may cause the offer distribution 140 to identify offers that are pertinent to the locality of the user at the new neighborhood, or alternatively, to a location of the user during transit. Thus, the geo-trigger 142 may generate an offer query which specifies a geographic location at a particular time in response to changes in locality by individuals that comprise the user group.

As another variation or alternative, the timing trigger 144 monitors the offer data store 112 for offers that are specified by merchants to become pertinent at a particular time (“timing triggers 143”). For example, a merchant may specify that an offer is good for lunchtime (e.g. 11:30 AM to 2 PM) on a particular day or set of days. When an offer is relevant to a particular time, trigger 144 may cause the offer distribution 142 to generate persons query 123 for individuals who may be interested in the offer (based one or more other relevancy parameters). Among other criteria, persons of interest may be generated based on the locality of the persons (as determined by user tracking 120) and the graphic region associated with the offer that is triggering.

Still further, some merchants may specify offers to be distributed immediately upon the creation of the offer. For example, a restaurant may create an offer just before lunchtime on a slow day, or alternatively, during lunch time on a slow day. When the offer is created and stored in the data store 112, offer distribution 140 generates persons query 123 in order to identify persons that would deem the offer relevant—such as those persons that are at a locality where the offer is relevant, and/or those persons who would be interested in the type of product or service specified in the offer.

With respect to the various implementations described in which offers are paired to customers, one or more embodiments may also utilize additional relevance factors or criteria in order to pair offers with users. Among the criteria, one or more embodiments factor user preference or habits in selecting offers for persons. Still further, some embodiments factor merchant preferences or designations in identifying users to pair with the merchant. In the latter case, for example, merchants may specify offers to be valid for new customers. The offer distribution 140 may, for example, make an initial selection of customers who are geographically or otherwise relevant to the merchant offer. The offer distribution 140 may access profile information 111 of the customers in order to make a determination of those customers (from the initial selection) whom are likely to be new customers for the merchant. For example, the selection may identify new customers to service 100, or those customers who have never previously accepted an offer from the merchant.

Offer pairing 130 generates paired offers 132, each of which identify a person and an offer from respective person data store 114 and offer data store 112. The offer communication 134 generates electronic communications to the person identified by each of the paired offers 132. The person data store 114 may access each user's profile information 111 to identify a messaging identifier (e.g. e-mail address, messaging identifier, social networking or instant messaging handle etc.) and preferred mode(s) of transport (e.g. e-mail or SMS). The offer communication 134 generates one or more communications for each paired offer 132. In one embodiment, paired offers are communicated to mobile devices in the form of offer content 155. The offer content 155 includes text and images that provide the offer. Alternatively, the offer content 155 may include a reference to a coupon or other record which contains required information or content (e.g. coupon) from which the offer can be procured.

The offer content 155 can be communicated by one or more modes of transport, including messaging transports, application notifications or social networking communications. In one embodiment, multiple transports and/or platforms are supported and used by transport delivery 175. The transport delivery 175 may implement, for example, different modes of transport to carry the offer content 155, including emails, SMS and/or mobile application notifications. For example, a person may walk about a neighborhood and receive a notification on their mobile device that contains an offer to a merchant that is in walking distance from the person.

With reference to embodiments described, some variations provide that the paired offers 132 do not include content that corresponds to the actual offer. The paired offers 132 may alternatively be in the form of communications that include information about offers. A user may need to perform additional acts to procure the offer for redemption with a particular merchant. For example, a user may be required to visit a network or website and download or print the offer.

As an alternative or variation, one or more embodiments provide that users of system 100 can manually specify their location in order to cause system 100 to locate offers having location relevance. Still further, one or more embodiments provide that the user's locality is determined from alternative sources, such as the user's information on a social networking application such as TWITTER, FACEBOOK or FOURSQUARE.

Methodology

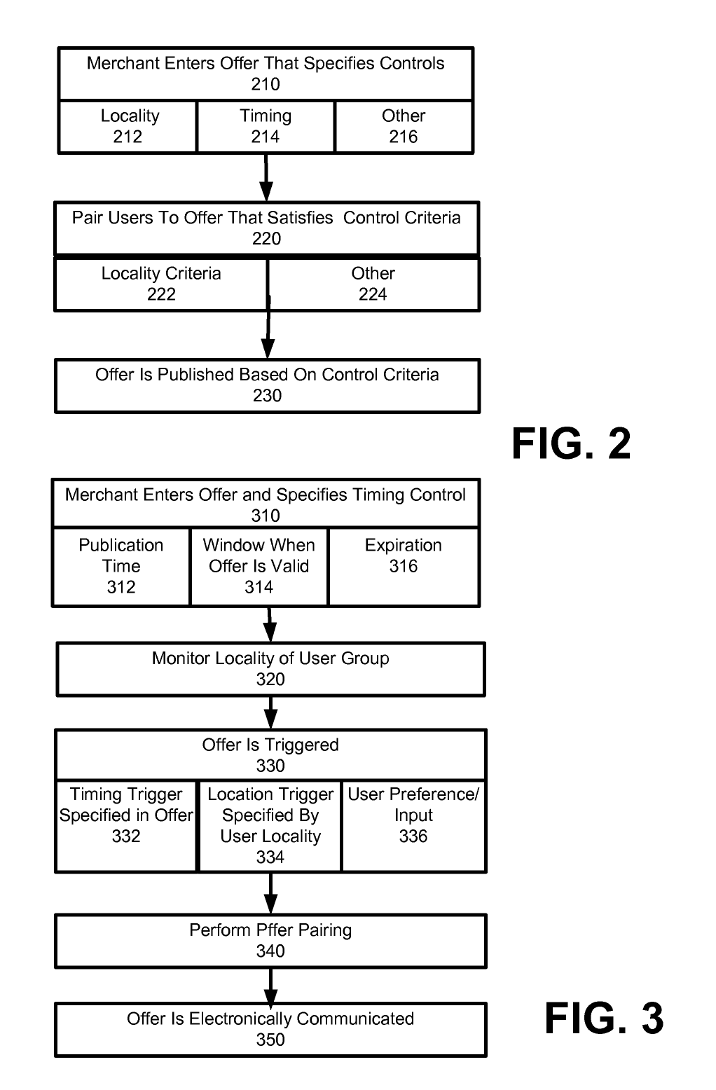

FIG. 2 and FIG. 3 each illustrate a method for enabling merchants to specify offers that are paired with persons based on contextual or relevance information, according to one or more embodiments. A method such as described by FIG. 2 or FIG. 3 may be implemented using a system such as described with an embodiment of FIG. 1. Accordingly, reference may be made to elements of prior embodiments for purpose of describing a suitable element or component for implementing a step or sub-step being described.

With reference to FIG. 2, a merchant may enter an offer that includes one or more control elements on how the offer can be used. For example, a merchant may specify via the merchant interface 110 the contents of offer 105, terms 107 applicable, and one or more controls 109 that regulate the use of the offer (210).

Various examples of controls may be implemented. In one embodiment, the controls may specify that persons who receive the offer are to be at, or near, a particular locality (212). The locality specified with the offer may be more specific than a general reference to a geographic region that can, for example, span a city, town or zip code. As an example, a local restaurant may seek an uptick in business at lunchtime. In this context, embodiments recognize that a mass communication to numerous persons that surround the restaurant may draw more traffic than the restaurant can handle. Rather, embodiments such as described enable the merchant (e.g. restaurant operator) to improve business from a specifically targeted clientele, such as those customers who work or live nearby, or those customers who reside in a particular city block or work at a particular location. Accordingly, the merchant may specify a locality for users that are to receive the offer. This may correspond, for example, a street address, a city block, a place of work or campus, a neighborhood, or a building. As another variation, the merchant may specify a radius or other spatial delimiter. At the time when the offer is distributed, those users or participants were within the radius specified by the merchant (which can be determined from the user geo-aware devices) can receive the merchants offer.

As another variation, the merchant may specify various geographic characteristics that are specific to multiple localities, or geo-characteristics. For example, a merchant may intend for individuals who work in select buildings in a city block to receive offers for discounts services of products. In order to implement the merchant's intention, offers are distributed to those users that are deemed to be physically present in one of the select buildings specified by the merchant at a particular time in the day which is presumed to be working hours (e.g. 10 AM).

Still further, in some variations, a merchant may specify an offer is to be distributed to those individuals who were at a particular locality at one or more past instances. Thus, historical localities of individual users may be taken into account in determining which users are to receive offers from a merchant. As an example, users who were in the vicinity of the business establishment on a prior day at lunchtime may receive offers for lunch time discounts on a following day, without further determination as to the locality of the user when the offers distributed (thus, the prior locality is to determine a factor).

As an addition or alternative to locality controls, timing controls may also be provided (214). Timing controls can specify (i) specific moments in time when the offers to be communicated, and/or (ii) specific time periods for which the offer is to be honored. For example, merchants may have the opportunity to provide an instant offer for lunchtime special either during or just before their lunch period. By timing the communication of the offer in this way, the restaurant tour may implement some control as to the expected volume or uptick in business that would result from the offer. Merchants may also roll offers over the course of a period (e.g. lunch time) to generate the uptick in a controlled manner. Still further, merchants may specify an expiration period for their offers. For example, an offer communicated to users may be valid for one day or one week.

Other controls may also be implemented (216). For example, controls can specify a classification of users that are to receive a particular offer. The classification of users may specify, for example, first-time users (of the merchant), users who specify a particular preferences in the profile information, or users who have frequented the establishment in the past (e.g., users who have visited a particular restaurant before but not recently). Numerous other user classifications may alternatively be designated, such as classifications based on other aspects of the user's profile information (e.g. demographic information, place of residence or work).

The merchant's offer may be paired to persons that satisfy the criteria specified in the offer, including the criteria provided through controls (220). For example, user data store 114 may be queried to identify persons that are available to receive offers, and from the group identified, those persons that have relevancy parameters and other information that satisfy the control parameters of a given offer may be identified. Among the relevancy parameters and information, users can be identified for a specific offer by their locality at a particular moment, or anticipated moment, when the offer is most relevant (222). As an alternative or addition, users may be identified based on other criteria such as their preference or availability to receive an offer at a particular time (224).

An electronic communication is then generated for each person that is paired to the offer (230). The electronic communication may include content that corresponds to the offer, including terms and control (or conditions) of the offer. Alternatively, the electronic communication may link to or refer to the offer, and provide the user with the ability to view and procure the contents of the offer from another source, such as an Internet website.

With reference to FIG. 3, other embodiments provide for the ability of the merchant to enter information corresponding to an offer, and further to specify controls for regulating distribution or use of the offer based on timing parameters (e.g. timing controls) (310). Such timing controls may include the publication time of the offer (312). The publication time may refer to the time in which the offer is to be communicated. According to various implementations, a merchant may select the publication time to correspond to, for example, a day, or more specifically a range of hours within a particular day. For example, a merchant may specify the hours of 9-11 AM for the communication of an electronic offer. With even more granularity, the merchant may actually specify a specific hour, half-hour, quarter hour, or instance (e.g. specific time of day) in which the offer is to be electronically communicated to the paired persons.

As an alternative or variation, the merchant can specify, as a type of control, a window of time in which the offer is valid (314). For example, the merchant may specify specific durations in a day when the offer is to be honored (e.g. happy hour, dinnertime). In addition to a window of time, a merchant may specify an expiration parameter (316). The expiration parameter may correspond to, for example, a specific time, or a specific condition. As a condition, the expiration parameter may designate that, for example, the offers to expire after X number of individuals receive the offer, and/or redeem or otherwise act on the offer. For example, an offer may include content that requests the user's input signifying their interest level, or even whether they accept the offer. The merchant may specify a limit as to the number of persons that receive the offer or otherwise act to respond to it. Still further, the expiration parameter may designate the merchant's ability to communicate or withdraw the offer at any time.

According to some embodiments, the localities of persons that comprise the user group of system 100 are monitored on an ongoing basis. In some implementations, persons that comprise a user group of system 100 may carry or use geo-aware devices, such as cellular telephony devices that include GPS resources. The monitoring of persons can be continuous, based on, for example, the availability of their mobile devices or settings/preferences. Alternatively, the monitoring of persons can occur at set durations during the day or other relevant time period, such as just before or during lunch, dinner or happy hour. Still further, the monitoring of persons can be in response to timing triggers that are generated from offers specified by merchants. For example, a merchant may specify a publication time with his or her offer, in which case system 100 may seek to identify the location of potential relevant customers just before when the offer is to be published.

Accordingly, some embodiments provide that merchant offers are triggered into being communicated to customers. The triggering may be responsive to, for example, timing criteria or conditions (332). The timing parameters can be specified by the merchant. As an alternative or addition, the triggering can be specified by parameters or settings of system 100 (e.g. identify all offers in the timeframe that is relevant to lunch on a given day). Still further, individual users of system 100 may specify settings, or provide manual input, that causes, for example, offer distribution 140 to query for pertinent offers at a given time of the end-users designation.

The triggering may alternatively be generated in response to location triggers generated by the movement or change in location of users (334). For example, users may travel by foot or car from one locality to another. With the change in locality, a triggering event may be realized in which it users new locality generates an update to available offers that are most pertinent to the particular new locality. The change in locality may be detected in response to the user's geo-aware device transmitting GPS information that is indicative of the new locality. A geo-aware device may alternatively identify a wireless network (or hotspot) or cellular tower that signifies the change in the user's locality. With reference to FIG. 1, the geo-trigger resources 142 of the offer distribution 140 may monitor the locality of the individual persons that comprise the user group at set times, or continuously, in order to detect relevant changes in localities of individual users.

Still further, other triggering event may be specified by user preferences or other events. Some users may specify a particular time during which they are to receive offers. For example, a user may specify that he is to receive offers on, for example, Monday mornings. Alternatively, a user may utilize an operational mode for system 100 in which the user prompts the system to deliver offers. For example, the user may open up an application as a triggering event. Alternatively, the user may operate the application and specify in input that signifies “retrieve relevant offers”. When such user input or action corresponds to a triggering event, some embodiments provide that the user's device communicates its locality to system 100, in order to retrieve geographically relevant offers from system 100 at that time. Other information, such as the users profile or preferences, may be maintained on the user device and or on resources of system 100.

Once pairing is initiated are triggered, individual offers are paired to persons, and vice-versa (340). Offer pairing can happen repeatedly or continuously during a given duration. For example offer pairing can occur several times during a given day on a systematic level, or once a day on individual or personal level.

Once offers are paired to persons, the offers can be electronically communicated (350). The electronic communication may be communicated through a messaging or notification medium, such as e-mail, instant messaging, SMS, application notification, or social networking update.

Presentations

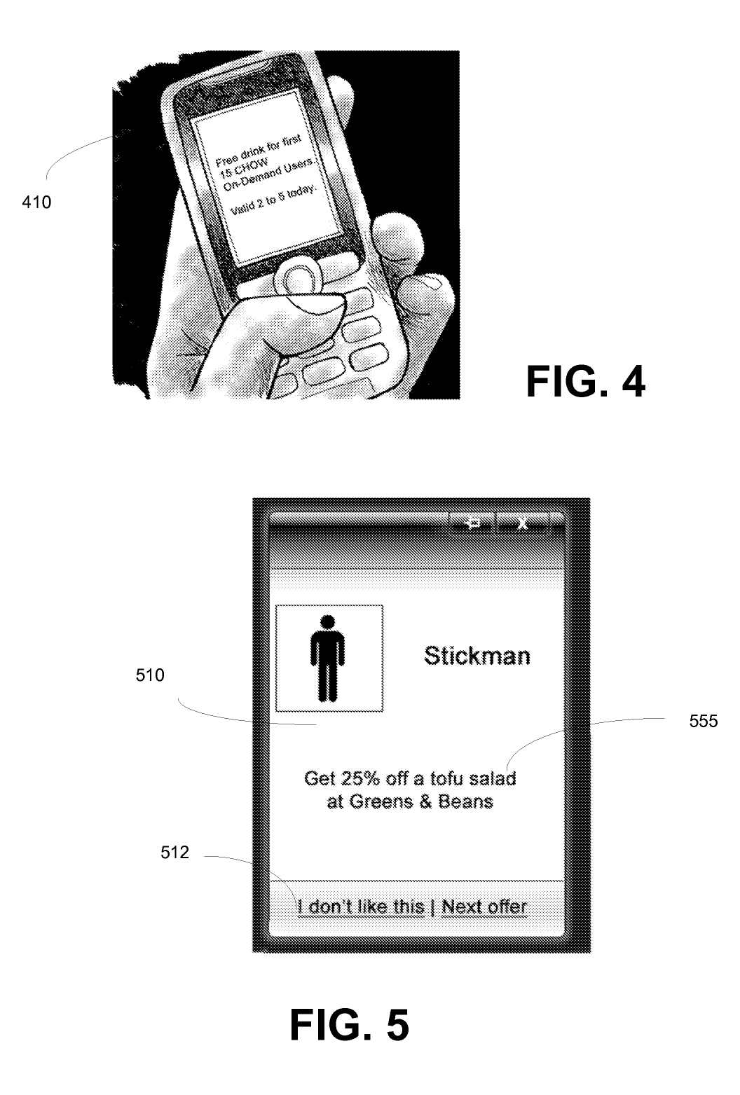

With reference to FIG. 1, offer content 155 may be communicated to users via messages/notifications. FIG. 4 through FIG. 8A illustrate various examples for presentations that can be generated with implementation of one or more embodiments described.

FIG. 4 illustrates an implementation in which a user operates a roaming, mobile device that is programmed to receive offer content, in accordance with one or more embodiments. A user's mobile device 410 can include inherent geo-aware functionality for identifying its location. The user device 410 communicates its location as a parameter from which offers related to that user location (e.g. when the geographic region of the merchant is proximate to the user's locality) are retrieved. In one implementation, the device 410 may transmit its position in response to a user prompt, such as a user opening an application that communicates with a service provided by, for example, system 100 of FIG. 1. Still further, the device 410 may be configured to automatically in repeatedly transmit its location to such a service, so as to enable a user position to trigger retrieval of pertinent offers to the user.

The offer presented may be composed by a merchant with controls that further refine how the offers to be used or made available, as well as who would find the offer most relevant or interesting. For example, in FIG. 4, the offers made available for class of “on demand users” who are registered users of a website for CHOW. This class of users may comprise only a portion of the total available users of the service provided by system 100. The class designation (“CHOW users” can be specified by the merchant as a control), or programmatically decided by resources of system 100.

The example provided by FIG. 4 also illustrates a control as to a window of time for when the offer is valid, for a particular day. More specifically, FIG. 4 illustrates a case in which a merchant seeks to boost business in a given time period, while not seeking to boost business during his or her rush-hour. The merchant may make the offer available in a given window of time that suits his or her needs. The offer may specify the window of time. In addition, the offer may be communicated at a time is most relevant to the window of time or opportunity. In the example provided, the window of time is between 2-5 PM. The offer may be communicated to users based on their locality, and their class designation (“CHOW users”) on a given day in which the offer is valid, before 2 PM or before 5 PM.

According to some embodiments, offer content 155 may be provided through the application that operates on end-user device. In FIG. 5, a presentation 510 may be generated from a client application that runs on, for example, a user's mobile device. In this regard, the application may provide the framework for presenting or rendering the offer content 555, as selected for a particular user. The presentation 510 may render multiple offers for a user, based on the user's locality relative to the location of the merchants providing the offers, as well as other parameters (e.g. user preferences). The presentation 510 includes a feature 512 for enabling the user to scroll through or view other offers deemed pertinent to the user. The sequence of offers presented to the user may reflect a priority that is based on relevance (e.g. those merchants who are closest to the user), preference of the user, or combination thereof. Multiple offers may be communicated to the user, so that that user can scroll through offers. In one implementation, a user is shown an individual offer, and provided another offer only if he declines the presented offer. Still further, a user may scan through multiple possible relevant offers by local restaurants for lunchtime offers on a given day, in order select a particular offer at a given time.

Still further, some offers may be set to expire based on, for example, a number of users who view and accept the offer. A user can scroll through offers and accept those that have not yet expired. Other variations to the examples recited are also possible.

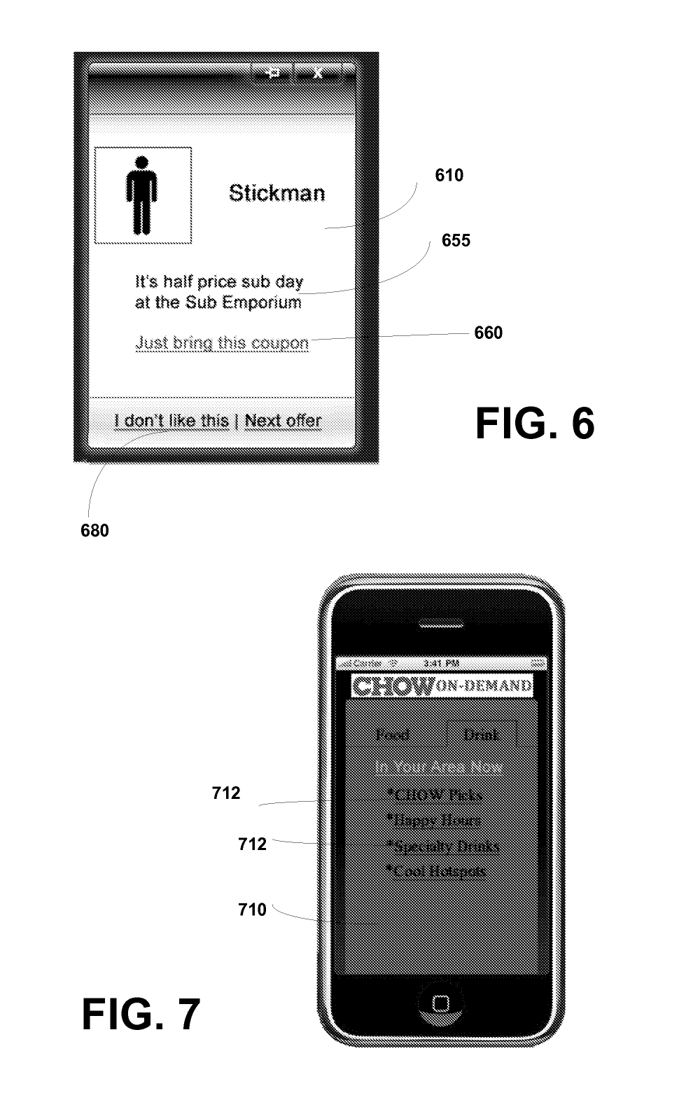

FIG. 6 illustrates a variation to offer content that is rendered to users, according to one or more embodiments. In FIG. 6, the presentation 610 includes offer content 655. The offer content 655 includes a link 660 to a coupon that contains the actual offer. Thus, the offer content 655 only links the user to the actual offer from the merchant. The link may direct the user to a site provided by either system 100, the merchant, or a third-party provider (e.g. coupon site).

FIG. 6 also illustrates an implementation in which a user is able to provide preference feedback about a particular offer. For example, a feature 680 enables a user to provide feedback corresponding to the user disliking the offer. As variations, the feature may identify when the user likes the offer. Still further, the user may provide a rating as to a degree of like or dislike for the offer. By receiving the feedback, one or more embodiments can update the user's profile for preferences on particular offers. This provides a mechanism for enabling preference to be used as an additional parameter for selecting offers that are relevant to the user.

As still another variation, the feature 680 can provide a mechanism by which an offer can be expired. For example, a merchant may designate an offer to expire once a certain number of persons view the offer and not dislike (or like) the offer.

FIG. 7 illustrates an alternative implementation in which a presentation 710 enables a user to browse for offers based on categories, according to one or more embodiments. In the example shown, multiple relevant offers are selected for a user based on relevancy parameters such as the locality of the user relative to the geographic region of the merchant providing the offer and the preference of the user. The presentation 710 may sort the relevant offers under category headers 712, such as editorial picks, by time or kind (e.g. lunch or happy hour), by product or by location.

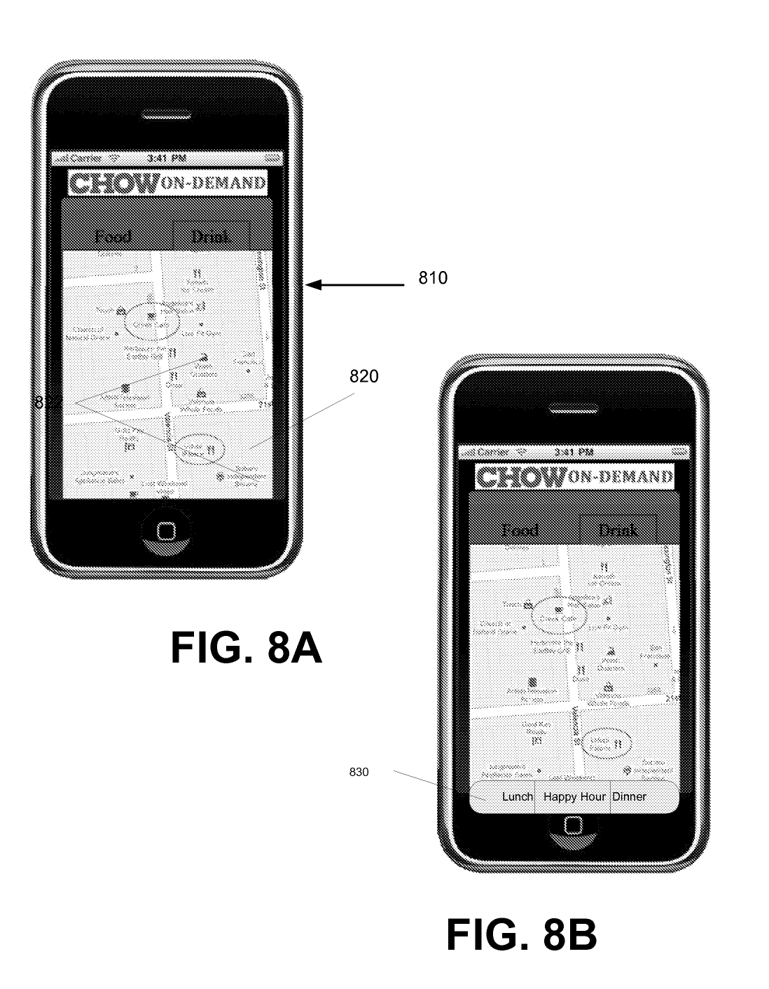

FIG. 8A illustrates an alternative presentation 810 in which a user is displayed a map having points of interest that correspond to the locations where special offers of are provided. For example, in a given neighborhood, a user may be displayed a map 820 that depicts locations 822 of restaurants that have special offers provided through system 100.

With reference to an embodiment of FIG. 8A, some embodiments encompass a user interface that enables a user to view offers by location, time period and/or kind. For example, as shown by FIG. 8A, a user may view a map of geographic region in order to view offers available at a particular time (e.g. lunch time).

With reference to FIG. 8B, the presentation 810 may further include a feature 830 that enables a user to select the time period (e.g. dinner time, day of week) in order to view offers by location (e.g. on map 820). In the example shown, the feature 830 enables the user can to select to view offers at a particular geographic region by a time periods for a given day. The time periods may be selected in the context of the particular type of product (e.g. restaurant offers separated by lunch, happy hour, and dinner). As another example, the user may view offers for a particular day of the week, at a particular region, using a map as described with an embodiment of FIG. 8A.

Still further, the time periods for which offers are provided may vary, and the user may change the contents of the presentation using a feature that shows what offers are available at what times. For example, a user may slide a bar in order to change a time period, and with the change in time period, the offers displayed to the user may change to what is available. For example, the user may view a map of a geographic region to view what stores have offers available for different days of the week.

As an addition or alternative, embodiments can enable the user to select offers by category. The categories may include type of product that is being offered (e.g. restaurant, consumer electronics, clothing). Still further, embodiments may enable the user to specify an offer search by sub-category (e.g. Chinese restaurant). Such a search may be combined with time and/or geographic search, as describe above. For example, the user may select an offer or product type, time period and geographic region in order to view offers that satisfy the criteria. Additionally, as described with an embodiment of FIG. 8A, the offers may be displayed on an interface such as a map.

Payment System and Method to Enable Users to Discretely Redeem Offers in Social Settings

Embodiments recognize that offers (e.g. such as provided with coupons or transmitted to mobile device) for some business establishments, such as restaurants, are typically redeemed by users in a social setting. In such settings, users often do not want their guests or peers to witness their redemption of a discount offer. Accordingly, some embodiments include programmatically facilitated payment techniques for users to discretely pay for products or services that are discounted. For example, some embodiments include a payment method or system for enabling users to pay for offers distributed through a system such as described with an embodiment of FIG. 1, or elsewhere in this application.

In one embodiment, a user can use a mobile device to initiate a payment using his or her mobile device. In particular, a mobile device (e.g. smart phone, tablet, smart card) may communicate data to enable a service to receive payment authorization, and/or to transfer funds from the user's account to that of the business establishment where the offer is being redeemed. For example, the user may elect to use an e-wallet to pay for a bill. The e-wallet may be operated on the user device, and the user device/e-wallet may carry information that automatically triggers a discount. Alternatively, the merchant may include a terminal or computing device that communicates the discounted amount due to the user's device or e-wallet.

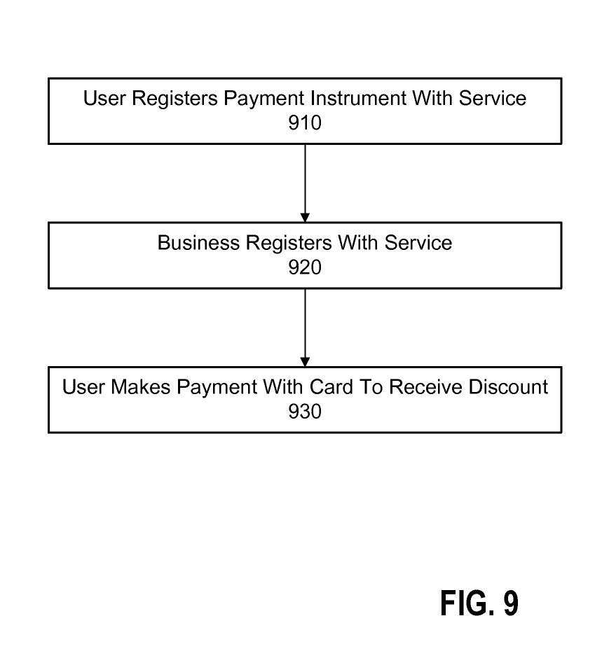

As an alternative or variation, FIG. 9 illustrates a method for enabling a customer to make payment to a business establishment for a product or service that is being offered to the customer on a discount basis, under an embodiment. As described, a method such as described with an embodiment of FIG. 9 enables the customer to make payment for a product or service, while discretely receiving a discount. A method such as described with FIG. 9 may be implemented in connection with offers distributed with, for example, system 100 of FIG. 1, or as described elsewhere in this application. Alternatively, a payment method such as described with an embodiment of FIG. 9 may be implemented independently of offer distribution systems and methods provided with other embodiments described herein.

In one embodiment, a user of the service registers a credit card or payment instrument (e.g. device with e-wallet) with the service (910). For example, a user may subscribe to a service provided through system 100, and as part of registering with the service, the user may specify credit card information.

Businesses may also register with the service in order to distribute offers or discounts to users of the service (920). The business may agree to have select transactions conducted at the business establishment to be handled through an alternative fund transfer technique as described below.

Embodiments include a process by which a user receives a discount in accordance with an offer being provided through the business at the time of the transaction, in response to a user making payment through a credit card or payment instrument that is registered (930). The use of the credit card or payment instrument may trigger the discount when used at a business establishment that has one or more offers distributed for discounts on a product or service. As an addition or variation, the use of the credit card or payment instrument may trigger a discount when used for a particular product or service that has a discount offer valid at the time of the transaction.

According to some embodiments, the discount can be provided to the user automatically, without the user having to perform any action other than to provide the registered credit card or payment instrument at the time of the transaction. Thus, for example, in a restaurant setting, the user may receive a check, and pay for the meal using a registered credit card. The fact that the user uses the registered credit card automatically qualifies them to receive a discount that is being offered at that particular time from the establishment. The discount can be applied to the credit card at the time of the transaction, or credited back to the user at a later time. In this setting, the user does not have to request the discount. In some variations, the waiter or individual who accepts payment from the user may not even know that the discount was applied. In this way, some of the awkwardness of users attempting to make payment for discount products or services in a social setting is eliminated.

As examples, when the business receives the customer's credit card, the business can perform a check to determine whether the card is one that is recognized by the service. This check can be performed independently, or as part of the normal credit card processing system. In one embodiment, a business may swipe a card with the specialized mechanism that transfers credit card information to a service to determine whether the credit card is registered with the service. In another implementation, a credit card transaction service automatically checks (e.g. with the service, or on a known list) in order to determine whether the credit card is registered to receive the discount for the particular user. Still further, numerous variations are possible as to how a credit card can be used at a business establishment in order to determine whether the credit card is associated with a person who is registered with the service and thus able to receive a discount (e.g. redeem a discount offer). For example, a business establishment may submit the name of the patron, and/or their credit card number, through a computer interface (e.g. computing device that accesses a webpage using a standard web browser; web application operating on a mobile computing device etc.) in order to determine whether the particular credit card is registered with the service.

If the credit card is registered, the business may submit the credit card to the service in order to cause a funds transfer between the patron and the business. The funds transfer may account for a discount to the patron. The fund transfer can be discounted automatically, and at the time the fund transfer takes place, so that the funds transferred from the customer to the business include the deduction for the offer or discount being provided by the business. Alternatively, a credit card authorization service may process the user's credit cards, and as part of its processing, determine instances when a credit card is being used to redeem an offer. This determination may be made on the assumption that a discount is applicable when (i) the credit card or holder of the credit card is registered for a service that offers discounts, and (ii) the business that seeks authorization from the card is offering a discount. Still further, another variation may award the redemption to the user based on the user purchasing a product or service that is on sale, or offered for discount, buy the business establishment.

Alternatively, the use of a registered credit card may trigger a separate redemption process in which the user receives cash or credit (to the card) independent of their payment to the business establishment through a traditional payment authorization mechanism. The name of the party entering In which a discount is automatically applied to the customer (i) who i numerous s registered with the service, and (ii) whom uses the registered credit card to pay for the product or service.

Still further, system 100 may maintain user funds for a deposit (which can correspond to a hold on the user's credit card). When the user redeems the offer, the credit card or payment instrument signals the funds for the discounted price.

Loyalty Programs

According to some embodiments, offers distributed for merchants may be provided in connection with loyalty programs that can enhance the discounts, product offering, and/or the level of benefit afforded to the user. In one implementation, a loyalty program may be operated to be specific to individual merchants. For example each merchant may have his own loyalty program when offers are provided through the service of system 100 (see FIG. 1). Alternatively, a loyalty program may be operated for a network of businesses or establishments.

In some implementations, a loyalty program operates for a service (e.g. such as provided through system 100) to reward persons for activities such as: (i) redeeming or attempting to use an offer distributed through system 100, (ii) registering for the service offered by system 100, (iii) making oneself available to receive offers, (iv) enabling gathering or collection of information that enhances the service's ability to select offers for the person (e.g. user can enable geo-tracking, user completes survey, provides preferences etc.), and/or (v) submitting a review for a merchant that provided an offer the user accepted. As an addition or alternative, a customer that frequents multiple businesses in the network may receive loyalty points that he or she can redeem for special offers, added discounts, and/or enhanced products or services.

Loyalty program offers may include, for example, offers for a person, or group of persons, to receive invitation only products or services. For example, a winery may make available a special wine tasting event to (i) patrons that have loyalty points to the winery, or (ii) to users of a service provided through system 100, whom redeem offers from other business establishments via the service and/or through the network that includes the winery.

Alternatives of Variations

Still further, some embodiments include a system that integrates an offer distribution system, such as described with various embodiments herein, with an inventory management system or process. In one embodiment, an inventory management system may monitor inventory of resources. In a restaurant, an inventory may coincide with food items of a particular kind that are unsold and/or being stored. With wineries, for example, inventory may refer to the amount of wine of a particular type and/or vintage. Other types of merchants may include other kinds of products (e.g. electronics, clothing).

According to an embodiment, an inventory management system is programmatically coupled or interfaced to an offer distribution system, such as described with an embodiment of FIG. 1. For example, a winery may detect an inventory glut, and make the inventory available for discount redemption via an offer distribution mechanisms such as described with various embodiments (e.g. see FIG. 1). The distribution of offers to items of excess inventory can be made automatically, or alternatively programmatically (e.g. notification to business operator, who can then be facilitated with offer distributions to the particular inventory).

In another variation, a user's experience with the merchant may be customized based on information communicated from the user's mobile device, or through other information known by the customer. For example, in one embodiment, a user may enter a merchant establishment to redeem a discount or offer. The users experience may be personalized with the merchant, based on profile information that can be associated with the user. Such profile information may be determined from, for example, the user's mobile device. The profile information can identify preferences of the user, past history of transactions from the user, and/or other information. In the context of a restaurant, for example, favorite food items of the user may be used to identify menu items that the user is most likely interested in.

In one implementation, a user's discount is applied to a personalized menu provided to the user. As mentioned, the personalized menu can be structured to accommodate one or more preferences or assumptions made for the user. The personalized menu may also include, for example, items selected for discount by the merchant because of, for example, considerations such as inventory.

As an example, a restaurant may communicate an offer via system 100. A user of system 100 may elect to accept the offer. When on premise of the merchant, the user may be provided recommendations that are selected for the user, or a menu (e.g. displayed on the user device) that accommodates or prioritizes items for the user selection based on preferences of the user. The preference information may be determined from information provided by the user to the system 100, or information determined by system 100 based on transactions and historical activity of the user.

Computer System

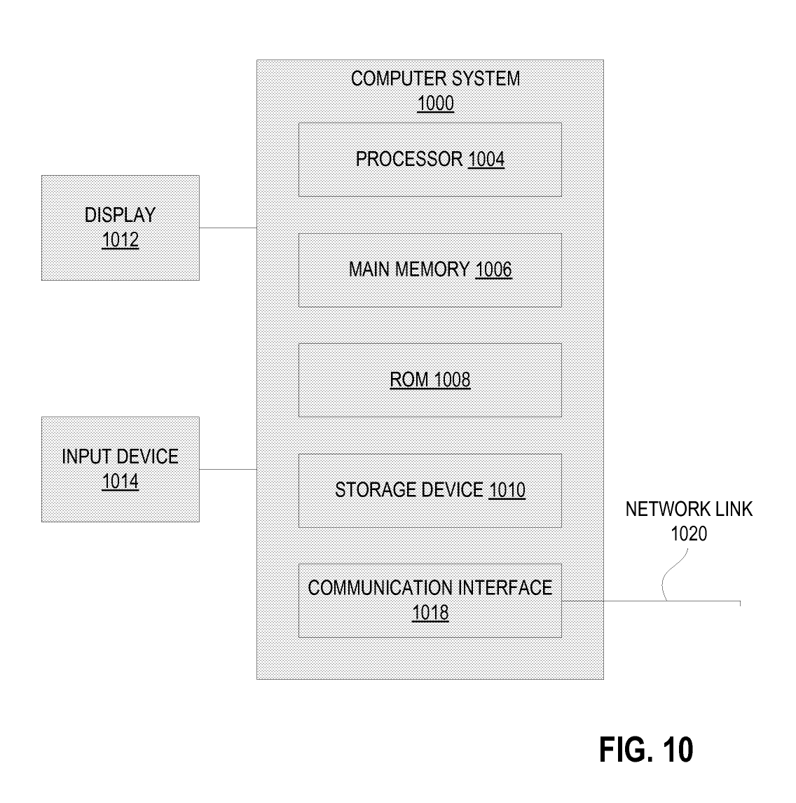

FIG. 10 is a block diagram that illustrates a computer system upon which embodiments described herein may be implemented. For example, in the context of FIG. 1, system 100 may be implemented using a computer system such as described by FIG. 10.

In an embodiment, computer system 1000 includes processor 1004, main memory 1006, ROM 1008, storage device 1010, and communication interface 1018. Computer system 1000 includes at least one processor 1004 for processing information. Computer system 1000 also includes a main memory 1006, such as a random access memory (RAM) or other dynamic storage device, for storing information and instructions to be executed by processor 1004. Main memory 1006 also may be used for storing temporary variables or other intermediate information during execution of instructions to be executed by processor 1004. Computer system 1000 may also include a read only memory (ROM) 1008 or other static storage device for storing static information and instructions for processor 1004. A storage device 1010, such as a magnetic disk or optical disk, is provided for storing information and instructions. The communication interface 1018 may enable the computer system 1000 to communicate with one or more networks through use of the network link 1020.

Computer system 1000 can include display 1012, such as a cathode ray tube (CRT), a LCD monitor, and a television set, for displaying information to a user. An input device 10110, including alphanumeric and other keys, is coupled to computer system 1000 for communicating information and command selections to processor 1004. Other non-limiting, illustrative examples of input device 10110 include a mouse, a trackball, or cursor direction keys for communicating direction information and command selections to processor 1004 and for controlling cursor movement on display 1012. While only one input device 10110 is depicted in FIG. 10, embodiments may include any number of input devices 10110 coupled to computer system 1000.

Embodiments described herein are related to the use of computer system 1000 for implementing the techniques described herein. According to one embodiment, those techniques are performed by computer system 1000 in response to processor 1004 executing one or more sequences of one or more instructions contained in main memory 1006. Such instructions may be read into main memory 1006 from another machine-readable medium, such as storage device 1010. Execution of the sequences of instructions contained in main memory 1006 causes processor 1004 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for enabling merchants to distribute offers, the method being implemented by one or more processors and comprising:
(a) enabling a merchant to create an offer that is associated with at least one geographic location;
(b) determining a locality where individual persons comprising a group of users are physically present;
(c) making a determination that the offer is relevant to one or more persons in the group, wherein the determination is based at least in part on the locality of the one or more persons as compared to the at least one geographic location of the merchant; and
(d) selecting to electronically communicate the offer to at least one of the one or more persons, based at least in part on the determination.

2. The method of claim 1, wherein (b) includes determining the locality of the individual persons at a particular time period during which the offer is relevant.

3. The method of claim 2, wherein (b) includes determining the locality of the individual persons during a portion of the day.

4. The method of claim 1, wherein (b) includes determining the locality of the individual persons using global positioning information transmitted from a device carried by each of the individual persons.

5. The method of claim 4, wherein (d) includes transmitting the offer to the device carried by each of the one or more persons.

6. The method of claim 1, wherein (a) includes enabling the merchant to specify one or more controls on how the offer can be used.

7. The method of claim 6, wherein enabling the merchant to specify one or more controls includes enabling the merchant to specify a time period in a day during which the offer is valid.

8. The method of claim 6, wherein enabling the merchant to specify one or more controls includes enabling the merchant to specify that the offer is valid for a duration that is less than a day.

9. The method of claim 6, wherein enabling the merchant to specify one or more controls includes enabling the merchant to specify that the offer is valid for as long as a number of redemptions of the offer is less than a stated quantity.

10. The method of claim 1, wherein (d) is performed in response to the one or more persons being determined to be at the locality.

11. The method of claim 1, wherein (d) is performed in response to the one or more persons being determined to be at the locality during a particular time period.

12. The method of claim 1, wherein (d) is performed in response to the one or more persons interacting with an interface of a device on which the offer is communicated.

13. A system for enabling merchants to distribute offers, the system comprising:
a user tracking sub-system that monitors a locality where individual persons comprising a group of users are physically present;
a merchant interface that is operable by a group of merchants, in order to enable each merchant in the group to create a corresponding offer for a product or service at a place of business associated with the merchant in the group;
wherein the merchant interface further enables the individual merchants to create the corresponding offer with one or more controls as to how the corresponding offer can be used;
an offer distribution sub-system, configured to:
pair the corresponding offer of one or more merchants with a set of users in the group, based at least in part on the geographic region associated with the one or more merchants and the locality of each user in the set of users; and
electronically communicate the corresponding offers of the one or more merchants to individual users in the set.

14. The system of claim 13, wherein the user tracking sub-system is configured to track the locality of individual persons in the group throughout a given time period, based on data transmitted from a geo-aware device carried by the individual persons in the group.

15. The system of claim 14, wherein the offer distribution sub-system includes one or more geo-triggers which detect an instance when the locality of a given person in the group changes from a first geographic region to a second geographic region, and wherein the offer distribution sub-system is configured to automatically pair the one or more corresponding offers that become relevant to the given person as a result of the locality of the given person being included within the second geographic region.

16. The system of claim 15, wherein the offer distribution sub-system is configured to electronically communicate at least one of the one or more corresponding offers to the given person in response to the locality of the given person being included within the second geographic region.

17. The system of claim 15, wherein the merchant interface is configured to enable merchants to specify the geographic region of relevance.

18. The system of claim 15, wherein the merchant interface is configured to enable each merchant to assign one or more controls to an offer of created by that merchant, the controls enabling the merchant to regulate use of the offer after the offer is created.

19. The system of claim 18, wherein the one or more controls that are assigned to the offer created from the merchant limit a time period in which the offer can be electronically communicated to users.

20. The system of claim 18, wherein the one or more controls that are assigned to the offer created from the merchant limit a time period in a day in which individual users of the set can use the offer.

21. The system of claim 18, wherein the one or more controls that are assigned to the offer created from the merchant limit communication of the offer to individual users who have not previously received or used an offer from the merchant in the past.

22. The system of claim 14, wherein the user tracking sub-system tracks a mobile device of each person in the group in order to determine the locality of the individual persons.

23. The system of claim 22, wherein the offer distribution system electronically communicates at least some of the corresponding offers of the merchants to mobile devices carried by individual users in the set.

24. A method for operating a computing device carried by a user, the method being implemented by one or more processors and comprising:
(a) communicating information that identifies a locality of the user at a particular time;
(b) receiving a set of one or more offers based at least in part on the locality of the user and the particular time; and
(c) generating a presentation that displays at least one of the offers in the set to the user by location.

25. The method of claim 24, further comprising generating the presentation to enable the user to view at least one offer for each of multiple time periods, for a particular geographic region that is determined to be relevant to the locality of the user.

26. The method of claim 24, wherein (c) includes enabling the user to view individual offers in the set by a selected time period.

27. The method of claim 24, wherein (c) includes enabling the user to view the individual offers in the set by a category or sub-category.

28. The method of claim 24, wherein (a) includes signaling Global Positioning System information from a device.
